(19) United States
(12) Patent Application Publication
(10) Pub. No.: US 2007/0240032 A1
(43) Pub. Date: Oct. 11, 2007

(54) Method and system for vertical acquisition of data from HTML tables

(76) Inventor: Jeff K. Wilson, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/400,517

(22) Filed: Apr. 7, 2006

(51) Int. Cl. G06F 15/00

(52) U.S. Cl. 715/509; 715/513

(57) ABSTRACT

A method, system and computer program product for performing equivalence checking of a circuit design are disclosed. The method includes receiving the hypertext markup language document to a system and displaying the hypertext markup language document in a display window in a browser. Responsive to a user selecting data within a table of the hypertext markup language document and dragging a cursor of the system in a vertical direction while depressing a button on a user input-output device of the system, content is passed from the table to a DOM interpreter and parsing of the selected data to a formatted data structure is performed. A cursor location of the cursor for an initial selection within the hypertext markup language document is identified and a specific column number of the location is noted. For one or more rows a user selects while dragging the cursor, a location of an entry on the row and the specific column is identified and vertical acquisition of data from tables in a hypertext markup language document is performed by passing the entry to the browser to identify and highlight as selected data.

### BACKGROUND OF THE INVENTION

1. Technical Field

The present invention relates in general to content delivery and in particular to transmission of information across in hypertext markup language. Still more particularly, the present invention relates to a system, method and computer program product for vertical acquisition of data from tables in a hypertext markup language document.

2. Description of the Related Art

In computing, HyperText Markup Language (HTML) is a markup language designed for the creation of web pages with hypertext and other information to be displayed in a web browser. HTML is used to structure information, denoting certain text as headings, tables, paragraphs, lists and so on, and can be used to describe, to some degree, the appearance and semantics of a document.

Originally defined by Tim Bemers-Lee and further developed by the IETF with a simplified SGML syntax, HTML is now an international standard (ISO/IEC 15445:2000), which is incorporated in its entirety herein by reference. Later HTML specifications are maintained by the World Wide Web Consortium (W3C). Early versions of HTML were defined with looser syntactic rules which helped its adoption by those unfamiliar with web publishing. Web browsers commonly made assumptions about intent and proceeded with rendering of the page. Over time, the trend in the official standards has been to create an increasingly strict language syntax; however, browsers still continue to render pages that are far from valid HTML.

The kinds of markup element types in HTML include structural markup, which describes the purpose of text. As an example, <h2>Golf</h2> directs the browser to render “Golf” as a second-level heading. Structural markup does not denote any specific rendering, but most web browsers have standardized on how elements should be formatted. For example, by default, headings like these will appear in large, bold text. Further styling should be done with Cascading Style Sheets (CSS). Presentational markup describes the appearance of the text, regardless of its function. For example, <b>boldface</b> will render “boldface” in bold text. In the case of both <b>bold</b> and <i>italic</i> there are elements which usually have an equivalent visual rendering but are more semantic in nature, namely <strong>strong emphasis</strong> and <em>emphasis</em> respectively. It is easier to see how an aural user agent should interpret the latter two elements. Hypertext markup. Links parts of the document to other documents. For example, <a href=“http://wikipedia.org/”>Wikipedia</a> will render the word Wikipedia as a hyperlink URL.

The HTML 3.0 standard was proposed by the newly formed W3C in March 1995, and provided many new capabilities such as support for tables, text flow around figures, and the display of complex math elements. Efforts of the web development community have led to a new thinking in the way a web document should be written; XHTML epitomizes this effort. Standards stress using markup which suggests the structure of the document, like headings, paragraphs, block quoted text, and tables, instead of using markup which is written for visual purposes only, like <font>, <b> (bold), and <i> (italics). Some of these elements are not permitted in certain varieties of HTML, like HTML 4.01 Strict. CSS provides a way to separate the HTML structure from the content's presentation, by keeping all code dealing with presentation defined in a CSS file. See separation of style and content.

Tables provide powerful tool for controlling page appearance. A table may have only one cell, or many. Tables may have borders of varying width (or none), colored backgrounds, fixed overall height/width, and other attributes. A TABLE is first specified with the <TABLE> tag, then a row in the table is opened with the TABLE ROW (<TR>) tag, then the contents of the row are defined for each cell with TABLE DATA (<TD>) tags. The last datacell and row are ended and a new row is begun, etc. The table is read by the browser as moving horizontally across the first row with cell information, then dropping to the next row, and so on until the table is complete.

TABLE DATA (contents for one cell) can include any amount of text, an image, a combination of text and image, multiple images, a list, text with line breaks or paragraph. Browsers poorly tolerate html errors in table construction; poor table formatting can result in extremely difficult debugging.

The browser creates cells in the order shown, i.e., first row, left to right; second row, left to right; then third row, left to right—and so on for as many rows and columns as are needed. The browser expects to “read” html in exactly the same order (left to right, across then down the table).

Unfortunately, users frequently need to copy vertical columns of tables, rather than the rows that are read and displayed, and most easily copied, by web browsers under the prior art.

### SUMMARY OF THE INVENTION

A method, system and computer program product for performing equivalence checking of a circuit design are disclosed. The method includes receiving the hypertext markup language document to a system and displaying the hypertext markup language document in a display window in a browser. Responsive to a user selecting data within a table of the hypertext markup language document and dragging a cursor of the system in a vertical direction while depressing a button on a user input-output device of the system, content is passed from the table to a DOM interpreter and parsing of the selected data to a formatted data structure is performed. A cursor location of the cursor for an initial selection within the hypertext markup language document is identified and a specific column number of the location is noted. For one or more rows a user selects while dragging the cursor, a location of an entry on the row and the specific column is identified and vertical acquisition of data from tables in a hypertext markup language document is performed by passing the entry to the browser to identify and highlight as selected data.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed descriptions of an illustrative embodiment when read in conjunction with the accompanying drawings, wherein:

FIG. 1 depicts a block diagram of a general-purpose data processing system with which a preferred embodiment of the present invention of a method, system and computer program product for vertical acquisition of data from tables in a hypertext markup language document may be used;

FIG. 2 is an example of table data illustrating vertical acquisition of data from tables in a hypertext markup language document in accordance with a preferred embodiment of the present invention; and

FIG. 3 is a high-level logical flowchart of a process for vertical acquisition of data from tables in a hypertext markup language document in accordance with a preferred embodiment of the present invention.

### DETAILED DESCRIPTION OF THE PREFERRED EMBODIMENT

The present invention provides a method, system, and computer program product for performing sequential equivalence checking with multiple initial states. The present invention includes a method for denoting which registers are to have constant and non-constant initial values, for identifying correspondence of initial states of one design to states of the other, and for performing an equivalence check upon the designs with all of their corresponding initial states in parallel. The present invention enables dramatic savings in computational resources for designs with multiple initial states in allowing them to run in parallel, and simplifies the process of specifying nontrivial initial value mappings between the two designs.

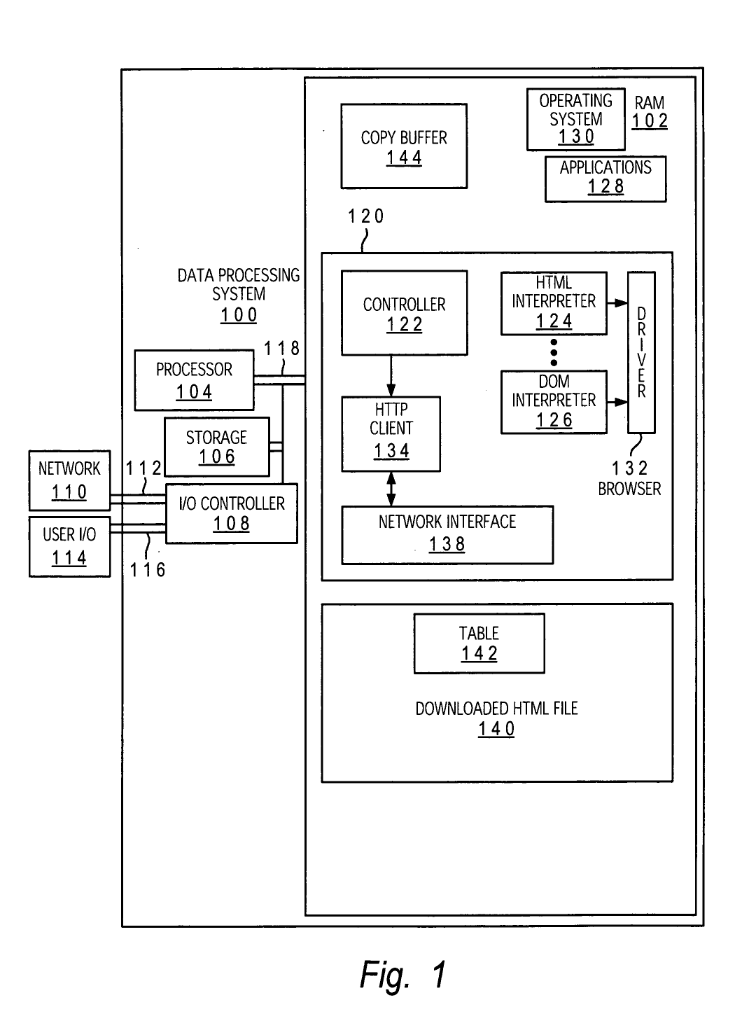

With reference now to the figures, and in particular with reference to FIG. 1, a block diagram of a general-purpose data processing system, in accordance with a preferred embodiment of the present invention, is depicted. Data processing system 100 contains a processing storage unit (e.g., RAM 102) and a processor 104. Data processing system 100 also includes non-volatile storage 106 such as a hard disk drive or other direct-access storage device. An Input/Output (I/O) controller 108 provides connectivity to a network 110 through a wired or wireless link, such as a network cable 112. I/O controller 108 also connects to user I/O devices 114 such as a keyboard, a display device, a mouse, or a printer through wired or wireless link 116, such as cables or a radio-frequency connection. System interconnect 118 connects processor 104, RAM 102, storage 106, and I/O controller 108.

Within RAM 102, data processing system 100 stores several items of data and instructions while operating in accordance with a preferred embodiment of the present invention. These include an operating system 130, a copy buffer 144, a browser 120, and applications 128. Browser 120 enables the viewing of a downloaded HTML file 140 containing a table 142. Within browser 120, a controller 122 guides the operation of an HTML interpreter 124, a DOM interpreter 126, driver software 132, and HTTP client 134 and a network interface 138. HTML interpreter 124 interpreter and document object model (DOM) interpreter 124 translate the content of downloaded HTML file 140 and provide output to driver 132 for provision to operating system 130 and direction to user I/O 114 through I/O controller 108 and wired or wireless link 116. HTTP client 134 handles the acquisition of data from network 110 over network cable 112 through the manipulation of operating system 130 under the supervision of network interface 138.

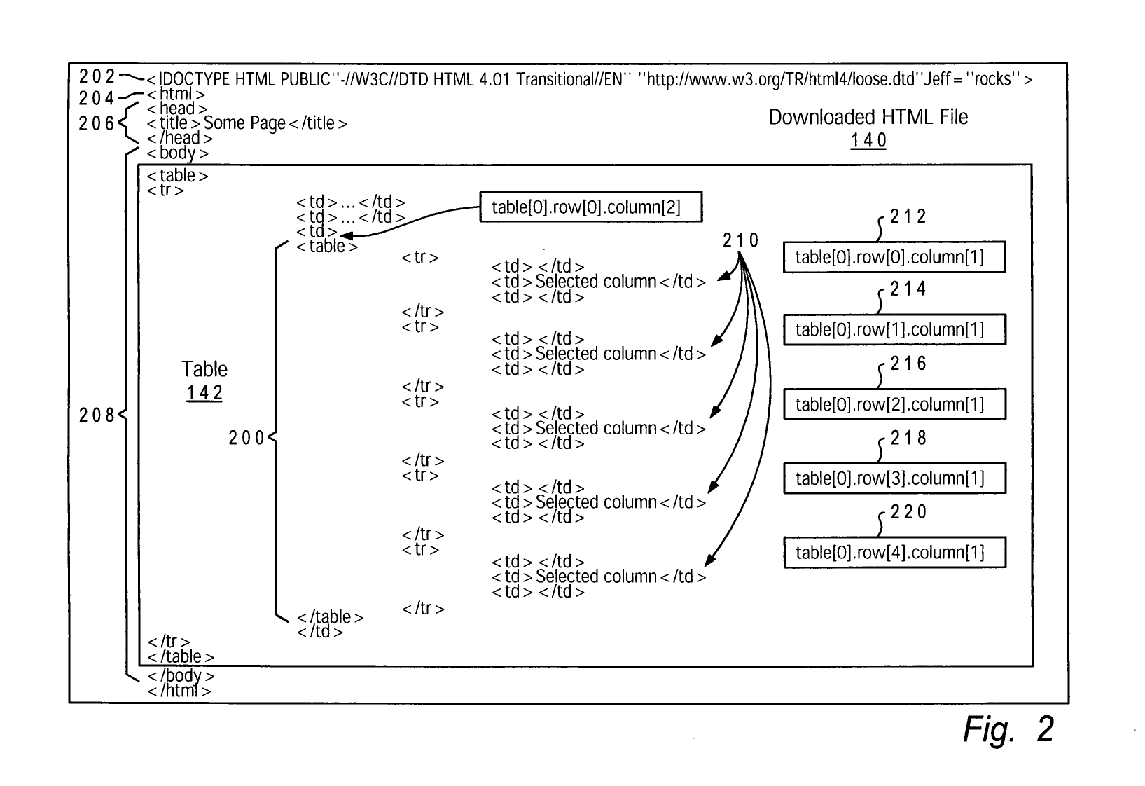

Turning now to FIG. 2, an example of table data illustrating vertical acquisition of data from tables in a hypertext markup language document in accordance with a preferred embodiment of the present invention is illustrated. Downloaded HTML file 140 contains a main table 142 and a subsidiary table 200. Downloaded HTML file 140 starts with a document type identifier 202 followed by an <HTML> tag 204 and a header 206. Body 208 contains main table 142 and a subsidiary table 200. Elements of a single column 210 are selected through use of a preferred embodiment of the present invention. Position indicators 212-220 are provided for clarity in the drawing, but are not part of downloaded HTML file 140.

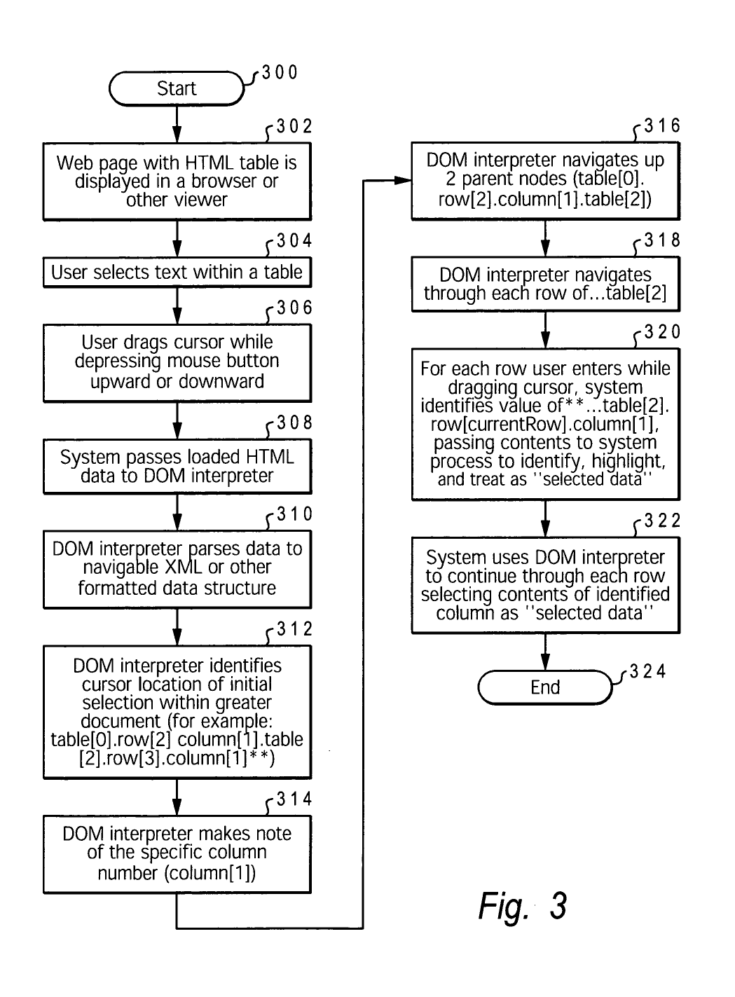

Referring now to FIG. 3, a high-level logical flowchart of a process for vertical acquisition of data from tables in a hypertext markup language document is depicted. The process starts at step 300 and then proceeds to step 302, which depicts browser 120 displaying downloaded HTML file 140 containing table 142. The process next moves to step 304. Step 304 illustrates a user using user I/O 114 to select text within table 142. The process then proceeds to step 306, which depicts a user using user I/O 114 to drag a cursor while depressing a mouse button upward or downward.

The process then moves to step 308. At step 308, controller 122 passes loaded HTML data from downloaded HTML file 140 to DOM interpreter 126. The process then proceeds to step 310, which depicts DOM interpreter 126 parsing data to navigable XML or other formatted data structures. The process next proceeds to step 312. At step 312 DOM interpreter 126 identifies a cursor location from user I/O 114 of the initial selection within downloaded HTML file 140. The process then proceeds to step 314.

At step 314, DOM interpreter 126 makes note of the specific column number within table 142 of downloaded HTML file 140 indicated by user I/O 114. The process then proceeds to step 316, which illustrates DOM interpreter 126 navigating up two parent nodes within table 142 of downloaded HTML file 140. The process then proceeds to step 318. At step 318, DOM interpreter 126 navigates through each row of table 142. The process next moves to step 320.

At step 320, for each row that a user enters with user I/O 114 while dragging a cursor, controller 122 identifies a value of table 142 in downloaded HTML file 140, passing contents to controller 122 to identify, highlight and treat as selected data. The process then moves to step 322. At step 322, controller 122 uses DOM interpreter 126 to continue through each row, selecting contents of the identified column as selected data. The process then ends at step 324. The user can then copy the data to a copy buffer 144.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communication links.

What is claimed is:

1. A method for performing vertical acquisition of data from tables in a hypertext markup language document, said method comprising:
receiving said hypertext markup language document to a system;
displaying said hypertext markup language document in a display window in a browser;
responsive to a user selecting data within a table of said hypertext markup language document and dragging a cursor of said system in a vertical direction while depressing a button on a user input-output device of said system, passing content from said table to a DOM interpreter;
parsing said selected data to a formatted data structure;
identifying a cursor location of said cursor for an initial selection within said hypertext markup language document;
noting a specific column number of said location;
for one or more rows a user selects while dragging said cursor, identifying a location of an entry on said row and said specific column; and
performing vertical acquisition of data from tables in a hypertext markup language document by passing said entry to said browser to identify and highlight as selected data.

2. The method of claim 1, further comprising copying said data to a copy buffer.

3. The method of claim 1, wherein said step of navigating through one or more rows of said table further comprises said DOM navigating through one or more rows of said table.

4. The method of claim 1, wherein said step of noting a specific column number further comprises said DOM noting a specific column number of said table within said hypertext markup language document.

5. The method of claim 1, wherein said step of parsing data to a formatted data structure further comprises parsing data to an XML-formatted data structure.

6. The method of claim 1, further comprising navigating up two parent nodes from said column number.

7. The method of claim 1, further comprising navigating through one or more rows of said table at said column number.

8. A system for performing vertical acquisition of data from tables in a hypertext markup language document, said system comprising:
receiving said hypertext markup language document to a system;
displaying said hypertext markup language document in a display window in a browser;
responsive to a user selecting data within a table of said hypertext markup language document and dragging a cursor of said system in a vertical direction while depressing a button on a user input-output device of said system, passing content from said table to a DOM interpreter;
parsing said selected data to a formatted data structure;
identifying a cursor location of said cursor for an initial selection within said hypertext markup language document;
noting a specific column number of said location;
for one or more rows a user selects while dragging said cursor, identifying a location of an entry on said row and said specific column; and
performing vertical acquisition of data from tables in a hypertext markup language document by passing said entry to said browser to identify and highlight as selected data.

9. The system of claim 8, further comprising copying said data to a copy buffer.

10. The system of claim 8, wherein said step of navigating through one or more rows of said table further comprises said DOM navigating through one or more rows of said table.

11. The system of claim 8, wherein said step of noting a specific column number further comprises said DOM noting a specific column number of said table within said hypertext markup language document.

12. The system of claim 8, wherein said step of parsing data to a formatted data structure further comprises parsing data to an XML-formatted data structure.

13. The system of claim 8, further comprising navigating up two parent nodes from said column number.

14. The system of claim 8, further comprising navigating through one or more rows of said table at said column number.

15. A machine-readable medium having a plurality of instructions processable by a machine embodied therein, wherein said plurality of instructions, when processed by said machine, causes said machine to perform a method, comprising:
receiving said hypertext markup language document to a system;
displaying said hypertext markup language document in a display window in a browser;
responsive to a user selecting data within a table of said hypertext markup language document and dragging a cursor of said system in a vertical direction while depressing a button on a user input-output device of said system, passing content from said table to a DOM interpreter;
parsing said selected data to a formatted data structure;
identifying a cursor location of said cursor for an initial selection within said hypertext markup language document;
noting a specific column number of said location;
for one or more rows a user selects while dragging said cursor, identifying a location of an entry on said row and said specific column; and
performing vertical acquisition of data from tables in a hypertext markup language document by passing said entry to said browser to identify and highlight as selected data.

16. The machine-readable medium of claim 15, said method further comprising copying said data to a copy buffer.

17. The machine-readable medium of claim 15, wherein said step of navigating through one or more rows of said table further comprises said DOM navigating through one or more rows of said table.

18. The machine-readable medium of claim 15, wherein said step of noting a specific column number further comprises said DOM noting a specific column number of said table within said hypertext markup language document.

19. The machine-readable medium of claim 15, wherein said step of parsing data to a formatted data structure further comprises parsing data to an XML-formatted data structure.

20. The machine-readable medium of claim 15, said method further comprising navigating up two parent nodes from said column number.
